(19) United States
(12) Patent Application Publication
(10) Pub. No.: US 2010/0066485 A1
(43) Pub. Date: Mar. 18, 2010

(54) REMOTE CONTROL OF MOBILE PHONE CAMERA

(75) Inventor: Edward Craig Hyatt, Durham, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB, Lund (SE)

(21) Appl. No.: 12/210,743

(22) Filed: Sep. 15, 2008

(51) Int. Cl. H04N 5/232

(52) U.S. Cl. 340/3.71; 340/3.1; 340/3.7; 348/552

(57) ABSTRACT

In a portrait mode of operation in a mobile communications device a phone camera can be automatically triggered to photograph an image in response to a sensed sound signal,. The portrait mode may be initially activated by the user by depressing a key on the phone keypad and/or a dedicated camera function button. A sound trigger signal can be detected from an input of the phone microphone. An indicator, such as a light emitting diode (LED) can be energized in the portrait mode and viewable from the position of image object. Thus the user can confirm that the portrait mode is operational.

### BACKGROUND

The present invention relates to mobile communications, more particularly to communication via wireless local area networks.

Mobile communication devices, such as cellular phones and the like, have become increasingly prevalent. These devices provide the convenience of a handheld communication device that is capable of increased functionality. An expanding variety of features have become available, for example, short or multimedia messaging, multimedia playback, electronic mail, audio-video capturing, interactive gaming, data manipulation, web browsing, and the like. Mobile terminals have been equipped with versatile location-awareness technologies, such as global position system (GPS) tracking features. Such features enable a consumer to monitor the terminal position as well as transmit its location to emergency response personnel during emergency situations.

Convenience and ease of use continue to be objectives for improvement. The focus of the structural design of mobile phones continues to stress compactness of size, incorporating powerful processing functionality within smaller and slimmer phones. To further these objectives, various devices have been developed and gained popularity, such as the flip phone, clam shell, slider, jack knife. Components of these devices are distributed within a housing of the phone body and a cover, which are movably coupled to each other. The cover may be in hinged or in slidable engagement with the housing.

A popular mobile phone feature is digital camera functionality. Such functionality is structured within the phone in a manner that emulates small hand-held digital cameras. The camera lens is mounted on a surface of the phone housing opposite that of the display upon which the lens image can be seen by the user. One or more phone keys are operable to implement various camera functions, including exposure and mode of operation, under control of the mobile controller. A self-portrait mode is typically provided. A single-shot timer can be implemented by depressing the appropriate key. The user then can move to an appropriate position in front of the lens before the timer expires and an exposure is taken.

The typical self-portrait mode can be inconvenient as there is a limited time in which the photographic subject must be composed. The user must activate the timer, position the phone so that the lens will capture the desired field of view, then move to a desired position in the field of view and pose before the timer expires. If the user seeks to be photographed in a grouping with others, there may be insufficient time to obtain the best grouping arrangement. A further deficiency is that only one exposure can be made for each setting. If it is desired to take a plurality of photographs of the same or different arrangement of subjects, the process must be repeated for each exposure.

A need thus exists for an improved alternative for camera phone portrait operation.

### DISCLOSURE

The above described needs are fulfilled, at least in part, by providing a portrait mode of operation in a mobile communications device wherein, in response to a sensed sound signal, a phone camera is automatically triggered to photograph an image. The portrait mode may be initially activated by the user by depressing a key on the phone keypad and/or a dedicated camera function button. Thereafter, a sound trigger signal is detected by a controller of the device from an input received from the phone microphone.

An indicator, such as a light emitting diode (LED), may be situated on a surface of the device. The indicator is energized in the portrait mode and viewable from the position of image object. Thus the user can confirm that the portrait mode is operational. Energization of the LED can be momentarily interrupted upon exposure of the image by the camera to indicate that an exposure has been taken. Alternatively, the phone may issue an audible signal, e.g., via loudspeaker or alarm, to indicate a photograph exposure.

Trigger sound determination may be performed by detecting a rapid deviation of sound from sensed ambient noise level. For example, the user could trigger exposure of a photo by stamping a foot, snapping fingers, clapping a hand against a body, or by other sharp sounds. As an alternative, speech recognition can be used as a trigger mechanism. A predetermined word or phrase may be chosen as a photo trigger and stored as data in the phone memory. Speech recognition processing can be performed on received speech signals to trigger an image exposure if the predetermined word or phrase is recognized.

The portrait mode remains operational after the exposure has been taken, as indicated by the continued energization of the LED. As the portrait mode is continuously activated until terminated by user command, various camera exposure mode settings are available in the portrait mode. A succession of image exposures can be taken in response to a corresponding generation of successive sound signals. Available camera exposure modes may include, for example, burst exposure mode and movie clip mode.

Still other aspects, features, and advantages will be readily apparent to those skilled in this art from the following detailed description, wherein preferred embodiments of the invention are shown and described, simply by way of illustration of the best mode contemplated. The invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawing and in which like reference numerals refer to similar elements and in which:

FIG. 1A is an illustrative view of structure of an exemplary mobile phone;

FIG. 1B is a pictorial illustration of the mobile phone in use during portrait mode operation;

FIG. 2 is block diagram of a mobile communication device such as the mobile phone shown in FIGS. 1A and 1B;

FIG. 3 is a flow chart of portrait mode operation; and

FIG. 4 is a chart representing a user sound photo trigger setup menu for portrait mode operation.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments.

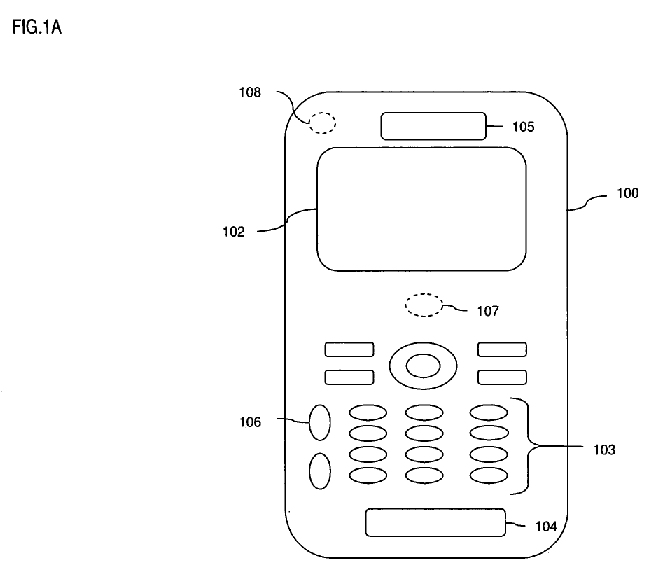

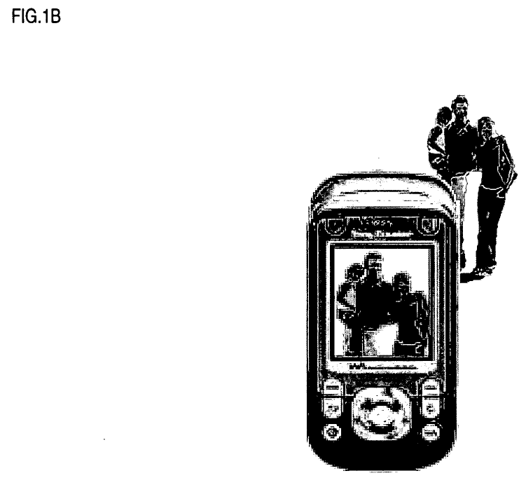

The mobile communication device is represented by a mobile phone 100 in FIG. 1A. The mobile phone may be encompassed within any suitable housing (or casing) 101, such as a fold (or clamshell) housing, slide housing, or swivel housing. Display 102, keypad 103, microphone 104, and speaker 105 are mounted on the housing surface shown. Additional user function keys, such as camera function key 106, are provided. The specific arrangement of user function keys is merely exemplary. An opposite surface of the housing contains camera 107 and LED 108, both represented in phantom.

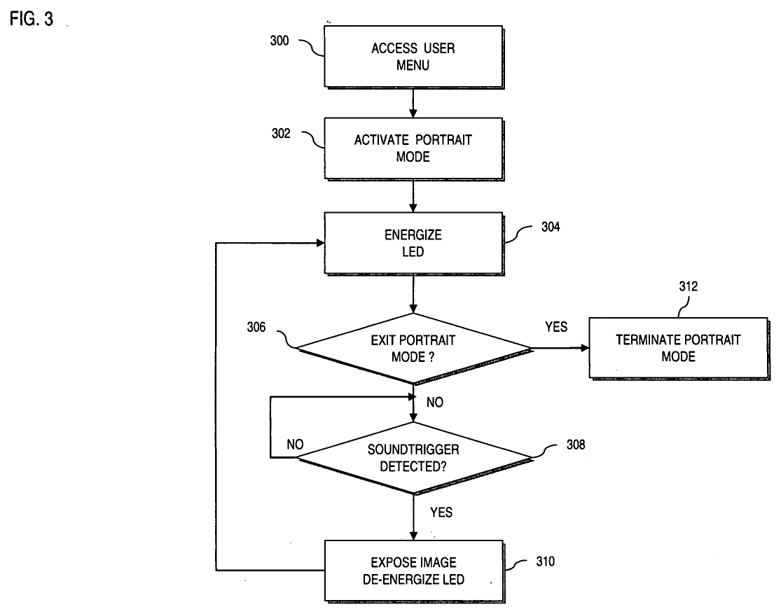

FIG. 1B is a pictorial illustration of the mobile phone in use during the portrait mode operation. Such operation is described in more detail with respect to the flow chart shown in FIG. 3. In the portrait mode, the user can position the mobile phone at the appropriate angle for capturing the desired photograph composition. As illustrated, the composition is a people grouping. As the portrait mode has been activated, there is ample time to arrange the people as desired. The user can then trigger an image disposure by issuing a sudden sound, as illustrated by a slap on the user's body. After the exposure, the camera is re-armed for the next picture. The user may issue another sound trigger to obtain a backup exposure without the need to reposition the people grouping. The objects may modify their poses for repeated exposures without readjustment of the phone controls.

The user can exit the portrait mode by depression of a phone key or button in accordance with a cameraphone menu. As any unwanted photos can be deleted by the user at a later time, exposures triggered by spurious noise should not be of concern. Adjustment of sound trigger sensitivity may be available to the user via cameraphone menu.

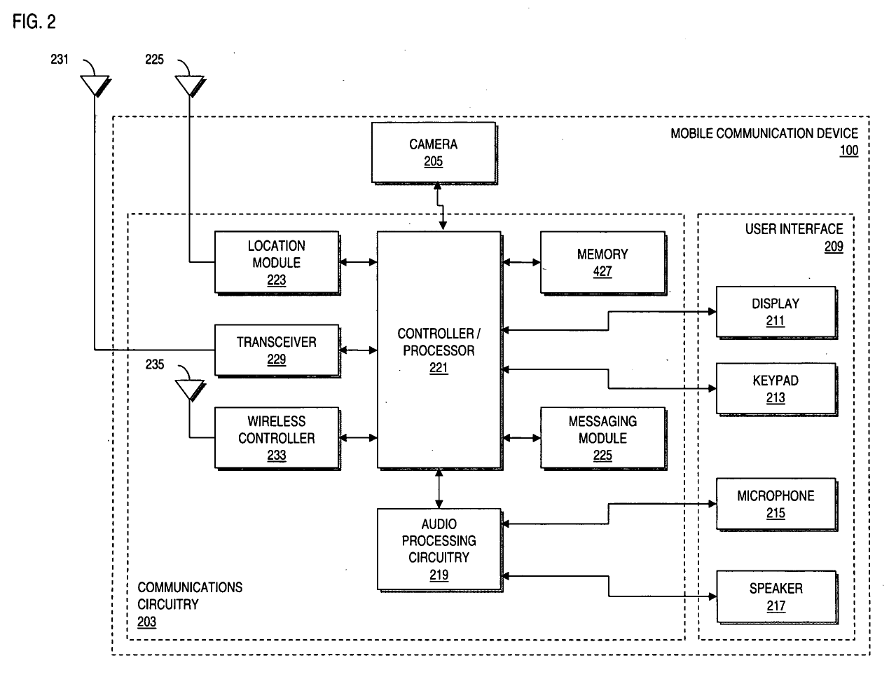

FIG. 2 is a block diagram of an exemplary mobile communication device 100, such as a cellular phone, laptop computer, or the like. User interface 209 includes display 211, keypad 213, microphone 215, and speaker 217. Display 211 provides a graphical interface that permits a user of the mobile communication device 100 to view call status, configurable features, contact information, dialed digits, directory addresses, menu options, operating states, time, and other service information, such as physical configuration policies associating triggering events to physical configurations for automatically modifying a physical configuration of mobile communication device 100. Keypad 213 is representative of conventional input mechanisms, which may also include a joystick, button controls, dials, etc. The graphical interface may include icons and menus, as well as other text, soft controls, symbols, and widgets. Display 211 enables users to perceive and interact with the various features of mobile communication device 100.

Microphone 215 converts spoken utterances of a user into electronic audio signals. Speaker 217 converts audio signals into audible sounds. Microphone 215 and speaker 217 may operate as parts of a voice (or speech) recognition system. Display 211 and speaker 217 can reproduce media content receive by the device from the host server.

Communications circuitry 203 enables mobile communication device 100 to initiate, receive, process, and terminate various forms of communications, such as voice communications (e.g., phone calls), SMS messages (e.g., text and picture messages), and MMS messages. In other instances, communications circuitry 203 enables mobile communication device 100 to transmit, receive, and process data, such as endtones, image files, video files, audio files, ringbacks, ringtones, streaming audio, streaming video, etc. Communications circuitry 203 includes audio processing circuitry 219, controller (or processor) 221, location module 223 coupled to antenna 225, memory 227, transceiver 229 coupled to antenna 231, and wireless controller 233 (e.g., a short range transceiver) coupled to antenna 435. Controller 221 is also coupled to messaging module 225.

Specific design and implementation of communications circuitry 203 can be dependent upon one or more communication networks for which mobile communication device 100 is intended to operate. For example, mobile communication device 100 may be configured for operation within any suitable wireless network utilizing, for instance, an electromagnetic (e.g., radio frequency, optical, and infrared) and/or acoustic transfer medium. In various embodiments, mobile communication device 100 (i.e., communications circuitry 203) may be configured for operation within any of a variety of data and/or voice networks, such as advanced mobile phone service (AMPS) networks, code division multiple access (CDMA) networks, general packet radio service (GPRS) networks, global system for mobile communications (GSM) networks, internet protocol multimedia subsystem (IMT) networks, personal communications service (PCS) networks, time division multiple access (TDMA) networks, universal mobile telecommunications system (UTMS) networks, or a combination thereof. Other types of data and voice networks (both separate and integrated) are also contemplated, such as microwave access (MiMAX) networks, wireless fidelity (WiFi) networks, satellite networks, and the like. Also coupled to controller 221 is camera 205. Camera 205 can capture digital images and/or movies. Image and video files corresponding to the captured pictures and/or movies may be stored to memory 227.

Portrait mode operation is exemplified in the flow chart of FIG. 3. At step 300, the user accesses a cameraphone menu by depressing either a dedicated camera button or a predetermined combination of keys. The portrait mode is activated at step 302 by selecting the appropriate option of the menu. The LED, or other light indicator, is activated at step 304. The user can now position the phone for capturing the appropriate setting and arrange the object or objects for the portrait. Step 306 is a decision block, determining whether the portrait mode is to remain operational. This determination is made by detecting that the cameraphone menu has not been further accessed.

If an affirmative determination has been made at step 306, the controller awaits receipt of a sound trigger at 308. During this time, ambient noise is received by the microphone. Various methods can be used to implement trigger detection. The trigger can be detected by comparing the absolute value of the received sound with a predetermined threshold level. Another method can take an average of the ambient noise level and trigger on any rapid deviation therefrom. The phone controller 221 has the digital signal processing capability to perform the comparator and differentiator functions.

When a sound trigger has been detected at step 308, the portrait image is exposed and the LED indicator is de-energized at step 310. The process flow reverts immediately to step 304. The blink of the LED confirms for the user that an exposure has been taken. As a further enhancement, the phone may issue a sound that emulates the click of a camera shutter. The continued illumination of the LED at step 304 confirms for the user that the camera is re-armed for another exposure.

It has been determined at step 306, that the cameraphone menu has been accessed and the user has entered an exit command, the portrait mode operation is terminated at step 312.

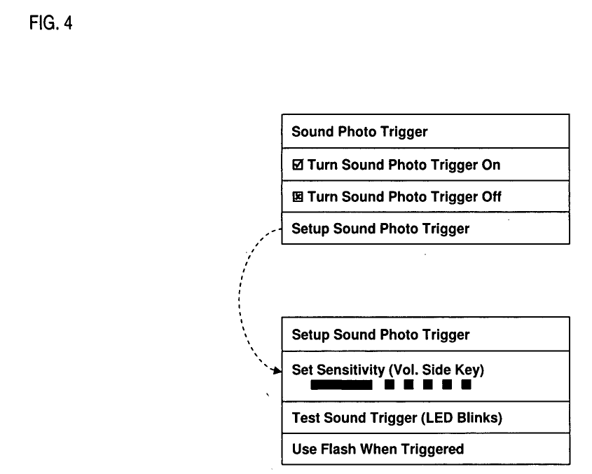

FIG. 4 illustrates an example camera sound trigger menu. The user activates this menu for display be pressing either a dedicated camera button or by a combination of keypad entries. The sound trigger menu may be displayed whenever the user chooses to take photographs. Alternatively, the sound trigger menu may be a submenu that is selected when a general command for camera operation is entered. The main menu offers options to turn the sound photo trigger on or off and to setup the sound photo trigger. Selection of the setup option produces a display of a submenu. The user then can set the sound sensitivity, for example, by adjusting the phone volume key. Energization of the LED sound trigger can be tested to determine whether the LED indicates a “blink” for camera exposure. A test can also be made for audible camera exposure emulation. A camera flash setting option may also be provided in the setup menu.

Among the advantages of the present disclosure is the capability to take self portraits by a camera phone without being encumbered by a time period limit. In addition, a plurality of self portraits may be made without the necessity to readjust phone settings. It is to be understood that the invention is capable of use in various other combinations and environments and is capable of changes or modifications within the scope of the inventive concept as expressed herein.

What is claimed is:

1. A method comprising:
activating a portrait mode of operation in a mobile communications device that comprises a camera;
sensing a sound signal;
in response to the sensed signal, automatically triggering the camera to photograph an image.

2. A method as recited in claim 1, wherein the step of sensing comprises detecting an input received by a microphone of the mobile communications device.

3. A method as recited in claim 2, wherein the step of sensing further comprises adjusting the sensitivity of microphone input.

4. A method as recited in claim 1, wherein the step of activating comprises indicating that the portrait mode is operational.

5. A method as recited in claim 4, wherein the step of indicating comprises energizing a light emitting device mounted on the mobile communications device.

6. A method as recited in claim 5, further comprising momentarily interrupting energization of the light emitting device upon exposure of the image by the camera.

7. A method as recited in claim 1, wherein the step of activating comprises manually contacting a key of the mobile communications device by a user.

8. A method as recited in claim 1, wherein the step of sensing comprises detecting a rapid deviation of sound from sensed ambient noise level.

9. A method as recited in claim 1, wherein the sound signal is a user speech signal, the step of sensing comprises applying speech recognition processing to the sensed speech signal, and the step of automatically triggering comprises determining that the recognized speech signal corresponds to a trigger command.

10. A method as recited in claim 1, wherein the step of triggering comprises exposing a succession of images in response to the sensed signal.

11. A method as recited in claim 1, wherein the step of triggering comprises initiating a movie clip exposure in response to the sensed signal.

12. A method as recited in claim 5, further comprising generating an audio signal upon exposure of the image by the camera.

13. A mobile communications device comprising:
a controller;
a microphone; and
a camera;
wherein the controller is configured to activate a portrait mode of camera operation and to automatically trigger the camera to photograph an image in response to a sound signal sensed by the microphone.

14. A mobile communications device as recited in claim 13, further comprising an indicator mounted on a housing of the mobile communications device and coupled to the controller;
wherein the controller is configured to energize the indicator during operation in the portrait mode.

15. A mobile communications device as recited in claim 14, wherein the indicator comprises a light emitting diode (LED).

16. A mobile communications device as recited in claim 15, wherein the controller is configured to momentarily interrupt energization of the LED upon exposure of the image by the camera.

17. A mobile communications device as recited in claim 13, further comprising a speaker coupled to the controller;
wherein the controller is configured to generate a command to the speaker for outputting an audio signal upon exposure of the image by the camera.

18. A mobile communications device as recited in claim 13, further comprising a user keypad coupled to the controller; wherein the controller is configured to be responsive to contact with a user key to activate portrait mode operation.

19. A mobile communications device as recited in claim 18, further comprising a memory coupled to the controller, the memory containing menu data for storing portrait mode functions definable by user key entry.

20. A mobile communications device as recited in claim 14, wherein the controller is configured to detect a rapid deviation of sound input received by the microphone from a sensed ambient noise level.
